(19) United States
(12) Patent Application Publication
(10) Pub. No.: US 2009/0024910 A1
(43) Pub. Date: Jan. 22, 2009

(54) ASYNCHRONOUS COMMUNICATION AND CONTENT SHARING

(75) Inventors: Hrishikesh Kamat, San Carlos, CA (US); James Ku, San Jose, CA (US); Per Reedtz Thomsen, Hughson, CA (US)

Correspondence Address: BEYER WEAVER LLP, P.O. BOX 70250, OAKLAND, CA, 94612-0250, US

(73) Assignee: MEDIA LASSO, INC., Santa Clara, CA (US)

(21) Appl. No.: 11/780,413

(22) Filed: Jul. 19, 2007

(51) Int. Cl. G06F 17/00; G06F 17/28; G06F 17/27; G06F 17/26

(52) U.S. Cl. 715/204; 715/232

(57) ABSTRACT

Techniques and mechanisms are provided for allowing a user to communicate and share content with other users in an asynchronous manner. A user can generate or dynamically create postings including video files, text, audio clips, greeting cards, calendar information, etc. A spatial plane or wall allows efficient manipulation and customization of posts. Other users can submit posts in a post tray and provide comments for any post on the wall of in the post tray.

### DESCRIPTION OF RELATED ART

The present disclosure relates to methods and apparatus for sharing content and communicating in an asynchronous manner.

A variety of electronic communication mechanisms exist. Some mechanisms such as email, instant message, and the file transfer protocol allow communication of different types of content between particular parties. Other mechanisms such as social networking sites, video and photo sharing sites, provide users with some mechanisms for widely sharing or distributing content. However, each of these electronic communication mechanisms have limitations and drawbacks. Consequently, it is desirable to provide improved methods and apparatus for asynchronous communication and content sharing.

### OVERVIEW

Techniques and mechanisms are provided for allowing a user to communicate and share content with other users in an asynchronous manner. A user can generate or dynamically create postings including video files, text, audio clips, greeting cards, calendar information, etc. A spatial plane or wall allows efficient manipulation and customization of posts. Other users can submit posts and provide comments for any post on the wall of in a post tray.

These and other features of the present invention will be presented in more detail in the following specification of the invention and the accompanying figures, which illustrate by way of example the principles of the invention.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates one example of a user wall.

FIG. 2 illustrates one example of a user wall having a comment tray.

FIG. 3 illustrates one example of a user wall having an expanded comment tray.

FIG. 4 illustrates one example of a posting.

FIG. 5 illustrates one example of a technique for managing postings.

FIG. 6 illustrates one example of a technique for managing comments.

FIG. 7 illustrates one example of a computer system.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of a spatial plane. However, it should be noted that the techniques of the present invention can be applied to a number of variations to a spatial plane. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a processor is used in a variety of contexts. However, it will be appreciated that multiple processors can also be used while remaining within the scope of the present invention unless otherwise noted. Furthermore, the techniques and mechanisms of the present invention will sometimes describe two entities as being connected. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Conventional mechanisms for communication and sharing content are limited. Some available communication mechanisms such as instant messaging and voice over IP (VOIP) are generally synchronous. Instant messaging and VOIP allow communication using text and voice. In some instances, video can be used along with text and voice. However, these communication mechanisms require that participants in a conversation be present and active simultaneously. If one of the participants is not present or active, instant messaging and VOIP revert to static and delayed mechanisms like email or bulletin boards. That is, instant messaging and VOIP will often require a participant to leave an email or a voicemail when the other participant is inactive or unavailable. These emails and voicemails are typically retrieved as a sequential listing of messages ordered by timestamp.

Some video sharing and photo sharing sites allow users to more widely distribute content. Content is uploaded to a site and made available to particular users or to the public generally. Content is again provided usually as a listing of content. Photos may be placed in rows and columns. Videos may be displayed in a column based on the upload timestamps. In some instances, photos and video may be retrieved using a search engine, and relevant results are provided as a list of relevant candidates. The content provider has some limited control over what a viewer sees. For example, the content provider can place pictures in particular groups or sort pictures in a particular order. The content provider can also display images or video using a particular background wall paper or color scheme. The content provider can also give images and video particular titles and tags to influence retrieval based on search terms. However, the way content is displayed to a user is largely out of the hands of a content provider.

Social networking sites also provide users with some ability to distribute content to particular users or to the public generally. Users can display listings of pictures, blog entries, and sometimes video. The content is frequently listed in columns or rows based on upload timestamps. In some instances, a user can select the order in which some content such as photos are displayed. However, display of much of the content including text, blog entries, etc, is provided in a strict time stamp based listing. Users can customize their pages using particular background wall papers or color schemes, or play selected music when a page is being viewed, but a user again has very limited control over the viewer experience.

A viewer also has limited ways of communicating back to a content provider or user in both content sharing and social networking contexts. Many social networking and blog sites allow viewers to submit comments to the content provider. A viewer can sometimes rate a particular picture or video. In some instances, a viewer can communicate with a user using some other channel such as email. However, the feedback is again provided as text boxes sorted in timestamp order. Ratings are received and an average is displayed. Viewers have very limited capabilities and limited mechanisms for responding and communicating to a content provider. Even for rich multimedia video content, a viewer can often only respond using text.

In some instances, a viewer can post a link to an external site that includes some video that responds to the video of the content provider. However, these external links often require different sites, additional registration, and different layouts and often result in disjointed user experiences. The limitations of external sites also apply to content providers or users seeking to communicate with viewers in a manner not fully supported by a social networking, content sharing, or direct communications mechanism. For example, a social networking site user may want to invite everyone on a friend list to a particular event. An external site may have to be used, leading to a possibly interrupted user experience.

Consequently, the techniques and mechanisms of the present invention allow individuals to communicate in a natural environment that allows extensive customization of the way in which content is presented. According to various embodiments, a spatial plane is provided for individuals to post or organize data and media. It should be noted that the spatial plane here is merely an abstraction for a physically manipulable space where any type of data can be posted and/or organized. In particular embodiments, the spatial plane is not limited to a two dimensional surface and can include three or more dimensions.

Pictures, text, blog entries, web camera videos, media clips, audio, calendar entries, etc. can be posted onto the spatial plane and arranged in a manner the content provider believes is appropriate. A viewer can respond in a similar manner by posting content onto the spatial plane. Entire multimedia conversations can occur across time zones in a natural and intuitive manner.

According to various embodiments, the spatial plane may also include layers of content. The layers of content can be sorted to display postings of a particular type or posting associated with a particular search term. Some layers would reflect the postings of the previous day or postings from a particular user. Layers can be hidden or deleted or reordered. Users can manipulate the spatial locations of postings of various types and provide content to friends and family members in a customizable and personalized manner not possible or envisioned in conventional mechanisms.

According to various embodiments, the spatial plane is a wall that an owner can customize and manipulate to provide rich objects to a user. The owner can place objects in various locations on the wall and customize rich objects. In particular embodiments, rich objects include video posts, photos, photo stacks, music boxes, greeting cards, roses, audio message, rich advertisements, etc. Viewing users will be able to mark particular walls as favorites to keep track of changes or updates on walls of their friends and family members. Users will have the option to view walls of their friends and family members as it is arranged by the owners or dynamically reconfigure the wall for different views using filters. The walls may be dynamically reconfigured to show only recently added content, or may be organized in order of popularity, or may be presented to show only objects that have comments made by friends of the viewer or contain references to the viewer.

The walls may also be configured to show specific content and layout to specific users or groups of users According to various embodiments, these walls presented in a customized manner to different groups and individuals are referred to herein as portas. In particular examples, a wall owner can specify different wall presentations for friends, family, coworkers, clubs, etc. Each group is presented with a different version of the same wall. According to various embodiments, each wall has it own customized characteristics such as background music, wallpaper, types of icons, type of content, and amount of content presented. In particular examples, a friends porta is visible only to friends. An individual who is included in multiple groups may have access to a friends porta and a coworkers porta. Views can be toggled using a porta icon.

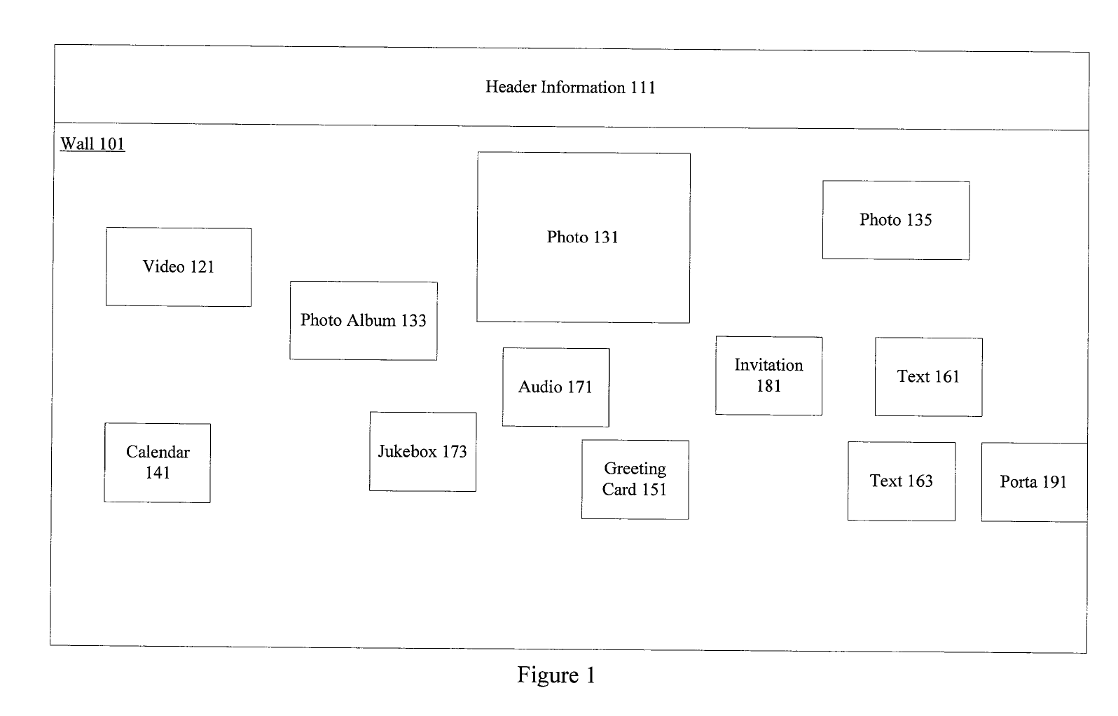

FIG. 1 illustrates one example of a spatial plane or wall. According to various embodiments, the wall includes header information 111 that provides information about the owner of the wall. The information may include the number of views, number of posts, number of friends, gender, status, location, school, or any other information personal or otherwise associated with the wall or the owner. The wall 101 also includes a number of rich objects such as photo 131, photo 135, and photo album 133. The objects provided on the wall may be thumbnails or the actual data, or may be representative icons. In particular embodiments, a photo object on the wall may be the full picture itself. The wall 101 also includes video 121, an audio object 171, and a jukebox 173. In some embodiments, the jukebox 173 may play even if it is not selected by a user. The wall also includes text messages 161 and 163. In some examples, the text may actually be displayed on the wall. In other examples, an icon may be provided. Other objects such as calendar 141, invitation 181, and greeting card 151 may also be presented and manipulated on a wall 101. A calendar 141 may expand to show a schedule. An invitation may expand to show an event invite list. A greeting card 151 may include text, audio, as well as video for or about a particular user.

In particular embodiments, the spatial plane or wall also provides a mechanism for switching between different presentations. In one example, a porta icon 191 is provided so that a user can select between a friends presentation, a family presentation, a coworker presentation, etc. A family presentation may have personalized content not available on a coworker presentation. When new content is added to a wall, a wall owner can administratively set preferences associated with the content object to indicate whether it would be presented on different portas and how it would be presented on different portas. In some examples, a friends photo may be posted in a central location on a friends porta while not being presented on a coworkers porta.

According to various embodiments, both the owner and viewers can manipulate and manage objects. In other embodiments, only the owner can manipulate and manage objects. Friends and family can interact with a wall by placing posts in a post tray or by using some other post submission mechanism. In particular embodiments, the post tray is hidden at the bottom of the wall. The post tray may be triggered by clicking on an icon or message that shows the total number of new messages in the post tray based on the viewing users last visit. This can also be the total number of unviewed posts by the viewing user. In particular embodiments, once the viewing user clicks on or mouses over the post tray bar, the post tray slides up to reveal friends posts to the wall.

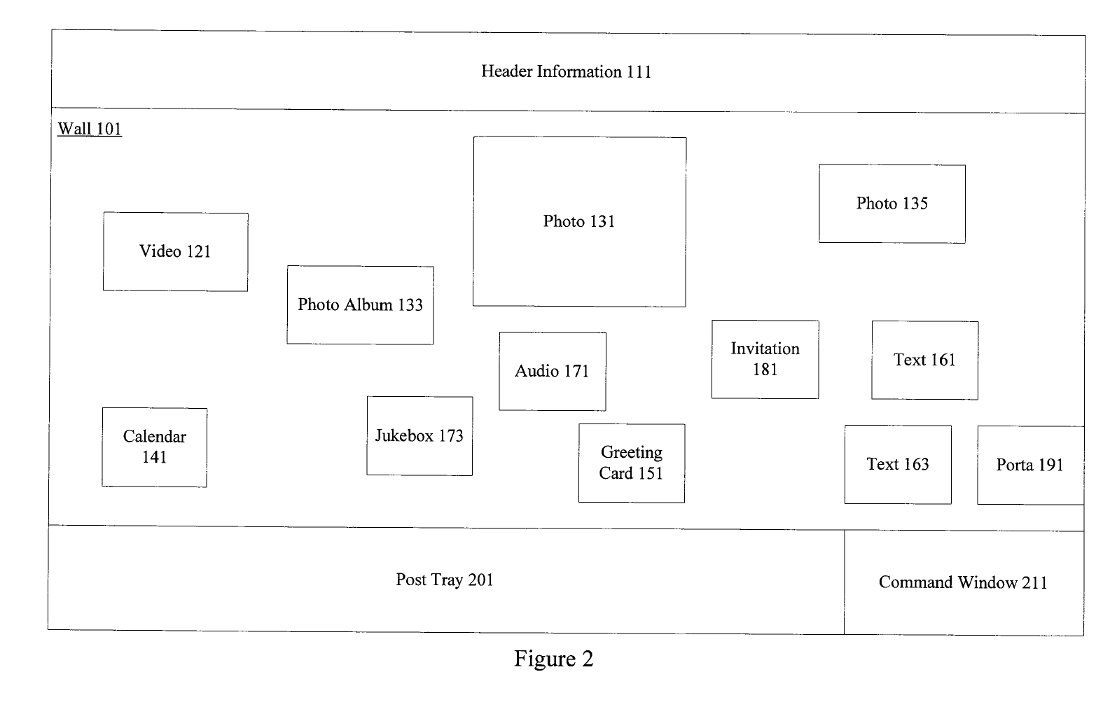

FIG. 2 illustrates one example of a post tray. A viewing user can quickly browse the avatar images of users that have posted recently. According to various embodiments, a viewing user mouses over or clicks on a message or icon to show a post tray 201. In particular embodiments, the post tray 201 shows recent posts. In other examples, the post trays shows avatars 221, 223, 225 of users who have posted. Posts on the post tray can have the same media type as rich objects on the wall, such as text, video, photo, audio, etc. To leave a new post, the viewing user can manipulate a button in a command window 211 to select a post type. One the post is completed and submitted, the post appears immediately in the post tray based on the sort bay setting. In particular embodiments, the default sort order will be the newest first.

According to various embodiments, the owner of the wall has the capability of dragging posts from the post tray directly onto the wall. An owner still has control over features such as placement, resizability, etc. Moving posts from friends onto the wall of the owner helps the social circle share rich media objects amongst themselves. Any type of rich object can be shared in this manner. In particular embodiments, the sharing is one way, as various friends and family can post to the post tray and the wall owner can move the post from the post tray to the wall.

According to various embodiments, each post can support comments, regardless of whether the post is submitted by the owner, friends, or family. In particular embodiments, a post by a particular friend can have comments from other friends. For example, a video post by a friend visible to other viewers can support comments from other viewers. To leave a comment, a viewer can click on a trigger such as a comment button associated with a post. The trigger causes a post tray to expand to show comments for the post. In particular embodiments, a viewing user can also click on friend avatars to show comments by particular friends for a particular post.

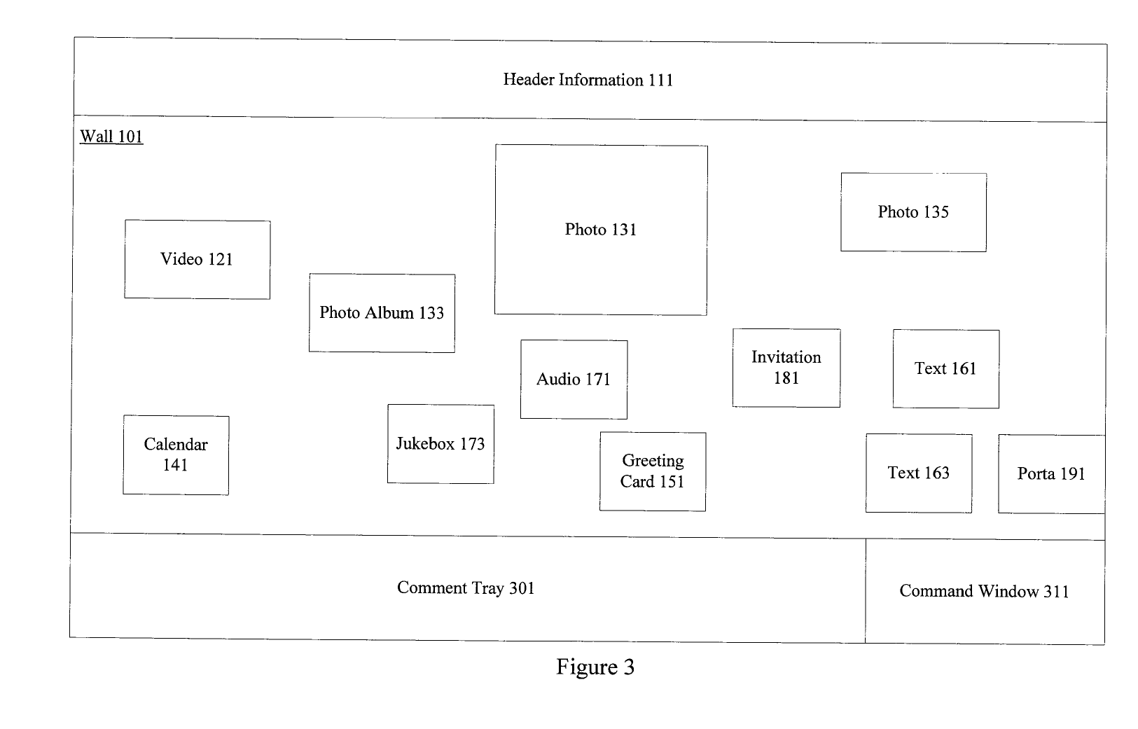

FIG. 3 shows one example of comments for a particular post. According to various embodiments, a comment tray 301 is expanded from a post tray. In particular embodiments, comments can themselves be text, photos, video, etc. For photos and video, users can view the content in the adjacent command window 311. When the comment tray is extended, the new post button in the command window 311 is changed to a new comment button. The comment tray 301 can be closed/collapsed with the close window button. When the comment tray is closed, the post tray can remain. In particular embodiments, if the comment tray is displayed and the post tray is closed, the entire tray including the post tray and the comment tray are closed. Any post, including posts by the owner on the wall and posts by friends in the post tray can have associated comments. When a viewing user wants to view the comments against the object posted by an owner, the user can click on comments to show an abbreviated comment tray.

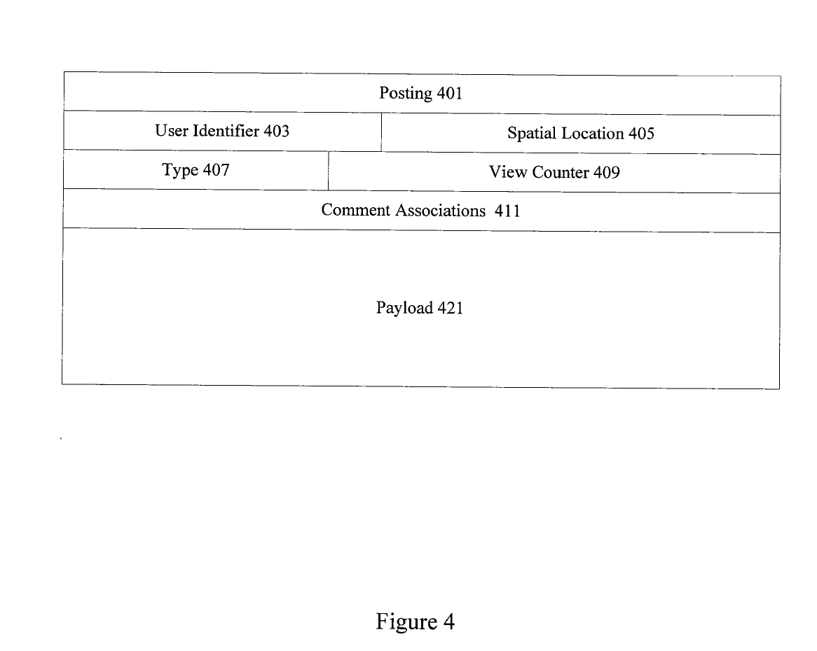

FIG. 4 illustrates one example of a post. According to various embodiments, a post can have a variety of structures and associated fields. Posting 401 is merely one illustrative example of post data. According to various embodiments, a posting 401 includes a user identifier 403 associated with the poster. Posters may include owners, friends, administrators, etc. Spatial location 405 provides a location for the post on the wall. According to various embodiments, the spatial location 405 is a pair of coordinates showing where to place the post on a grid. A type field 407 identifies the type of data, such as video, audio, text, etc. The posting 401 may also be associated with a view counter 409 indicating how frequently a post has been viewed. Comment associations 411 may allow comments to be included in a posting 401 structure. Alternatively, comment associations 411 may reference comments for the posting. The payload 421 includes the actual data for the post.

In particular embodiments, a posting 401 is also associated with layer information, providing information on how a posting should be displayed if it overlaps with another posting on the spatial plane. A posting 401 can also be associated with a number of other fields such as time information, size, etc.

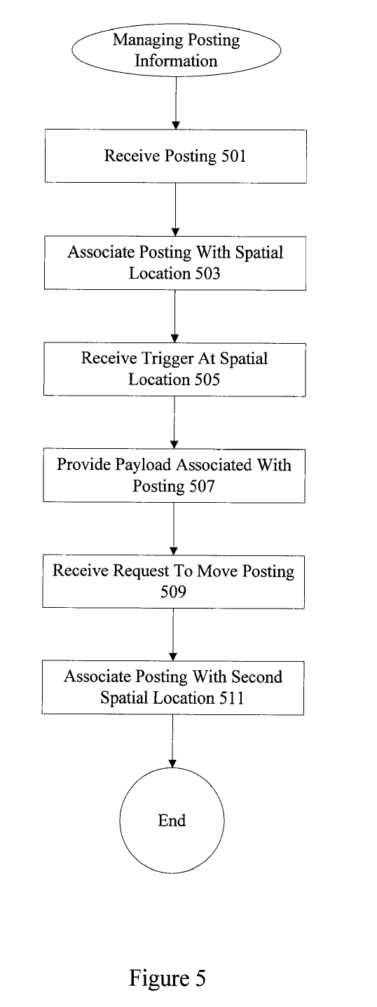

FIG. 5 illustrates one example of a technique for managing posts. At 501, a posting is received. According to various embodiments, a posting is received from an owner for display on a wall. The owner may upload or dynamically create content and place the posting in a particular position on the wall. At 503, the posting is associated with a particular spatial location. In some examples, a posting by a friend may simply be placed in a post tray and may not have a particular spatial location. A posting on the wall may or may not overlap with other postings. At 505, a trigger is received at the spatial location associated with the posting. According to various embodiments, the trigger is a mouse click or a mouse over. At 507, the payload associated with the posting is provided. In some examples, a smaller version of the content is provided when a user moves a curser over the posting. A full version of the content is provided when a user clicks to request to view the full version. The smaller version may be one scene of a particular video sequence, an album cover for a music playlist, or a thumbnail of a photo. At 509, a request is received to move the posting. The posting may be moved from one location on the wall to another location. In some examples, an owner may also want to move a posting from a posting tray to a particular location on the wall. At 511, the posting is associated with a second spatial location or a new spatial location if the posting did not have one before.

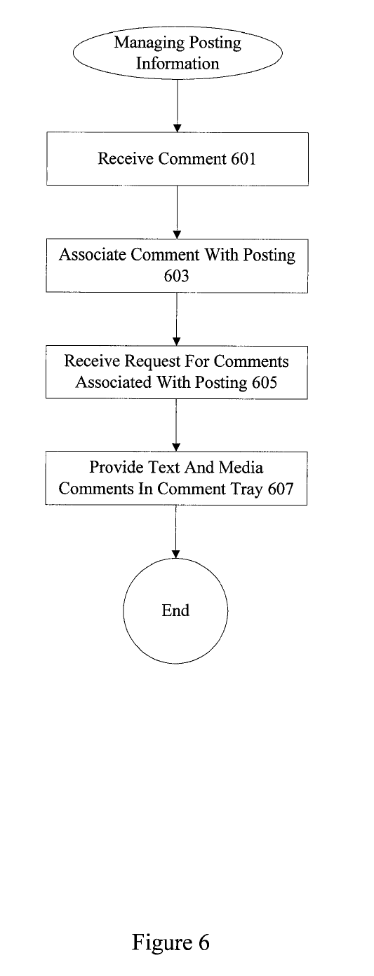

FIG. 6 illustrates one example of a technique for managing comment information. At 601, a comment is received. The comment may be intended for a post on a wall on a post included in a post tray. At 603, the comment is associated with the posting if not already associated. At 605, a request is received to view comments associated with a posting. The request received may be in the form of a mouse click or a mouse over. At 607, text comments can be provided in a comment tray. Video and other media comments can be provided in a command window associated with the comment tray.

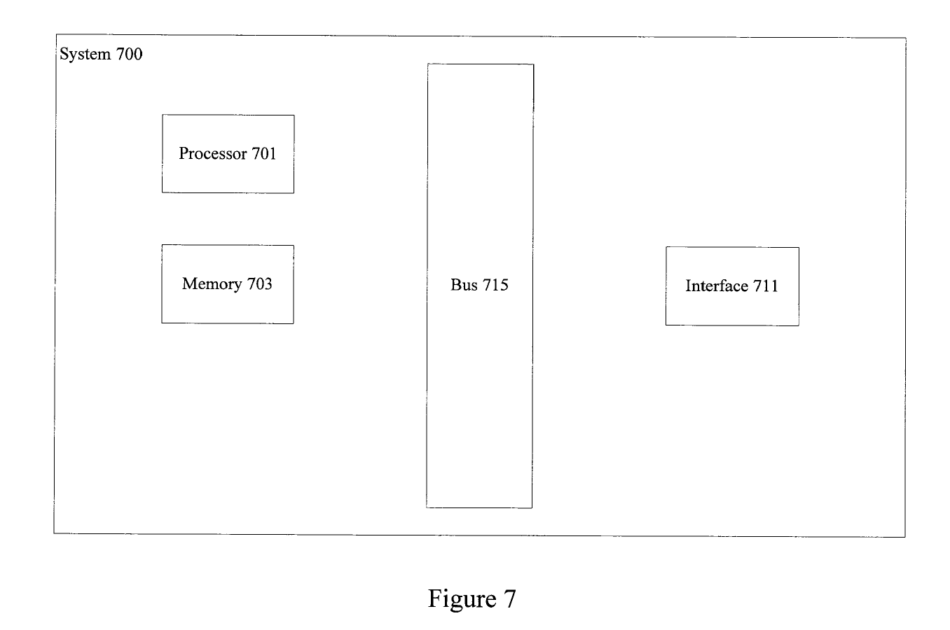

FIG. 7 illustrates one example of a device that can be used for providing a spatial plane for postings while managing postings and comment information. According to particular example embodiments, a system 700 suitable for implementing particular embodiments of the present invention includes a processor 701, a memory 703, an interface 711, and a bus 715 (e.g., a PCI bus). When acting under the control of appropriate software or firmware, the processor 701 is responsible for such tasks such as elephant trap and counting multistage filter management. Various specially configured devices can also be used in place of a processor 701 or in addition to processor 701. The interface 711 is typically configured to send and receive data packets or data segments over a network. Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

A spatial wall can be accessed using a browser or a native application. According to particular example embodiments, the system 700 uses memory 703 to store data and program instructions. The program instructions may control the operation of an operating system and/or one or more applications, for example. The memory or memories may also be configured to store received data including video and text information.

Because such information and program instructions may be employed to implement the systems/methods described herein, the present invention relates to tangible, machine readable media that include program instructions, state information, etc. for performing various operations described herein. Examples of machine-readable media include, but are not limited to, magnetic media such as hard disks, floppy disks, and magnetic tape; optical media such as CD-ROM disks and DVDs; magneto-optical media such as optical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. For example, embodiments of the present invention may be employed with a variety of master and slave components and should not be restricted to the ones mentioned above. Although shared I/O lines have been described in the context of a memory controller and a simultaneous multiple master component switch fabric, shared I/O lines can be used in a system without a memory controller and/or without a simultaneous multiple master component switch fabric. It is therefore intended that the invention be interpreted to include all variations and equivalents that fall within the true spirit and scope of the present invention.

What is claimed is:

1. A method, comprising:
receiving a plurality of postings, each of the plurality of postings associated with a user identifier and a payload;
associating the plurality of postings with a plurality of spatial locations on a spatial plane, wherein a first posting is a video posting associated with a first spatial location, a second posting is a photo posting associated with a second spatial location, and a third posting is text posting associated with a third spatial location;
receiving a first trigger at a user selected spatial location corresponding to one of the plurality of postings;
providing the payload included in one of the plurality of postings.

2. The method of claim 1, wherein the first spatial location is a two dimensional coordinate position in a window.

3. The method of claim 1, wherein the plurality of postings include text postings, photo postings, and audio/video postings.

4. The method of claim 1, wherein each of the plurality of postings further includes a user avatar, a view count, a content rating, and a report toggle.

5. The method of claim 4, wherein the view count is the number of times viewed.

6. The method of claim 4, wherein the rating score is a cumulative display of ratings information.

7. The method of claim 1, further comprising receiving a first comment in response to the first posting.

8. The method of claim 7, wherein the first comment is embedded in a comment tray.

9. The method of claim 7, further comprising receiving a second trigger at a spatial location corresponding to the first comment.

10. The method of claim 9, further comprising presenting the comment.

11. The method of claim 10, further comprising receiving a user action to move the comment from the comment tray to a fourth spatial location.

12. The method of claim 1, wherein the first, second and third spatial locations reside on a wall.

13. The method of claim 1, further comprising associated the plurality of postings with a plurality of portas.

14. The method of claim 13, wherein the plurality of portas include different presentations of the wall to different groups and individuals.

15. The method of claim 14, wherein the plurality of portas include a family porta and a friends porta.

16. An apparatus comprising:
means for receiving a plurality of postings, each of the plurality of postings associated with a user identifier and a payload;
means for associating the plurality of postings with a plurality of spatial locations on a spatial plane, wherein a first posting is a video posting associated with a first spatial location, a second posting is a photo posting associated with a second spatial location, and a third posting is text posting associated with a third spatial location;
means for receiving a first trigger at a user selected spatial location corresponding to one of the plurality of postings;
means for providing the payload included in one of the plurality of postings.

17. The method of claim 16, wherein the first spatial location is a two dimensional coordinate position in a window.

18. The method of claim 16, wherein the plurality of postings include text postings, photo postings, and audio/video postings.

19. A computer readable medium comprising:
computer code embodied on the computer readable medium for receiving a plurality of postings, each of the plurality of postings associated with a user identifier and a payload;
computer code embodied on the computer readable medium for associating the plurality of postings with a plurality of spatial locations on a spatial plane, wherein a first posting is a video posting associated with a first spatial location, a second posting is a photo posting associated with a second spatial location, and a third posting is text posting associated with a third spatial location;
computer code embodied on the computer readable medium for receiving a first trigger at a user selected spatial location corresponding to one of the plurality of postings;
computer code embodied on the computer readable medium for providing the payload included in one of the plurality of postings.

20. The method of claim 19, wherein the first spatial location is a two dimensional coordinate position in a window.
